(19) United States
(12) Patent Application Publication
(10) Pub. No.: US 2017/0048732 A1
(43) Pub. Date: Feb. 16, 2017

(54) EVALUATING PERFORMANCE OF REMOTE UNITS ON A PER REMOTE UNIT BASIS IN A DISTRIBUTED ANTENNA SYSTEM (DAS)

(71) Applicant: Corning Optical Communications Wireless Ltd., Airport City (IL)

(72) Inventor: Parwiz Shekalim, Netanya (IL)

(21) Appl. No.: 15/042,641

(22) Filed: Feb. 12, 2016

Related U.S. Application Data
(60) Provisional application No. 62/204,116, filed on Aug. 12, 2015.

(51) Int. Cl. H04W 24/08; H04B 17/318; H04L 12/26; H04B 7/155

(52) U.S. Cl. CPC H04W 24/08; H04B 7/15507; H04B 17/318; H04L 43/0882

(57) ABSTRACT

Evaluating performance of remote units on a per remote unit basis in a distributed antenna system (DAS) is disclosed. From a cellular network perspective, because each remote unit in a DAS is connected to the same cell transceiver of a base station, the individual remote coverage areas in the DAS are treated as one coverage area with the cell of the connected base station. Thus, in certain aspects provided herein, at least one performance indicator regarding the remote units in the DAS is determined on a per remote unit basis in the DAS, since each remote unit has its own remote coverage area that can have distinct and varying performance from other coverage areas in the DAS. The performance indicator can be communicated to a network or other system that is configured to analyze the performance related information and/or determine optimizations for the DAS to improve quality of service (QoS).

### CROSS-REFERENCE TO RELATED APPLICATION

This application claims the benefit of priority under 35 U.S.C. §119 of U.S. Provisional Application Ser. No. 62/204,116, filed Aug. 12, 2015, the content of which is relied upon and incorporated herein by reference in its entirety.

### BACKGROUND

The technology of the present disclosure relates generally to evaluating performance of remote units in a distributed antenna system (DAS) on a per remote unit basis.

Wireless communication is rapidly growing, with ever-increasing demands for high-speed mobile data communication. Distributed communications or antenna systems communicate with wireless devices called “clients,” “client devices,” or “wireless client devices,” which must reside within the wireless range or “cell coverage area” in order to communicate with an access point device. Distributed antenna systems are particularly useful to be deployed inside buildings or other indoor environments where client devices may not otherwise be able to effectively receive radio-frequency (RF) signals from a source, such as a base station for example. Example applications where distributed antenna systems can be used to provide or enhance coverage for wireless services include public safety, cellular telephony, wireless local access networks (LANs), location tracking, and medical telemetry inside buildings and over campuses.

One approach to deploying a distributed antenna system involves the use of RF antenna coverage areas, also referred to as “antenna coverage areas.” Antenna coverage areas can be formed by remotely distributed antenna units, also referred to as remote units (RUs). The remote units each contain or are configured to couple to one or more antennas configured to support the desired frequency(ies) or polarization to provide the antenna coverage areas. Antenna coverage areas can have different cell ranges depending on the channel conditions, areas, “client populations,” etc. Usually smaller cell ranges are employed for indoor areas with a radius in the range from a few meters up to twenty (20) meters, as an example. Combining a number of remote units creates an array of antenna coverage areas. Because the antenna coverage areas each cover small areas, there typically may be only a few users (clients) per antenna coverage area. This arrangement generates a uniform high quality signal enabling high throughput supporting the required capacity for the wireless system users.

As an example, FIGS. 1A and 1B illustrate distribution of communications services to coverage areas 100(1)-100(N) of a DAS 102, wherein ‘N’ is the number of coverage areas. These communications services can include cellular services, wireless services such as RF identification (RFID) tracking, Wireless Fidelity (WiFi), local area network (LAN), WLAN, and combinations thereof, as examples. The coverage areas 100(1)-100(N) may be remotely located. In this regard, the remote coverage areas 100(1)-100(N) are created by and centered on remote units 104(1)-104(N) connected to a central unit 106 (e.g., a head-end controller or head-end unit). Any of the remote units 104(1)-104(N) may be remote antenna units. The central unit 106 may be communicatively coupled to one or more base stations 108. Each base station 108 has its own antenna (not shown) for transmitting downlink communications signals 110D over the antenna and receiving uplink communications signals 110U from the antenna for supported communications services. Because the central unit 106 is communicatively coupled to the base station 108, the central unit 106 also receives the downlink communications signals 110D in multiple frequency bands for supported communications services from the base station 108 to be distributed to the remote units 104(1)-104(N). The remote units 104(1)-104(N) are configured to receive downlink communications signals 110D from the central unit 106 over a communications medium 112 to be distributed as downlink communications signals 110D to the respective coverage areas 100(1)-100(N) of the remote units 104(1)-104(N). Each remote unit 104(1)-104(N) may include an RF transmitter/receiver (not shown) and a respective antenna 114(1)-114(N) operably connected to the RF transmitter/receiver to wirelessly distribute the communications services to user equipment 116 (e.g., cellular phones, wireless mobile devices, etc.) within their respective coverage areas 100(1)-100(N).

With reference to FIG. 1A, the remote units 104(1)-104(N) in the DAS 102 are also configured to receive uplink communications signals 110U in multiple frequency bands from the user equipment 116 in their respective coverage areas 100(1)-100(N). The uplink communications signals 110U received in multiple frequency bands can be routed to different uplink path circuits (not shown) in the remote units 104(1)-104(N) related to their frequency band. At the related uplink path circuits in the remote units 104(1)-104(N), the uplink communications signals 110U can be filtered, amplified, and combined together into the combined uplink communications signals 110U to be distributed to the central unit 106. The central unit 106 can separate out the received combined uplink communications signals 110U into their respective bands to distribute to the base station 108.

As discussed above, the central unit 106 of the DAS 102 is communicatively coupled to the base station 108. An operational and support system (OSS) 117 can be provided in an operations and maintenance center (OMC) that is linked to base stations, such as base station 108, to manage the base stations as part of a cellular network. The OSS 117 can obtain network performance related data for granularity of cell or subscriber unit in a cell to determine cell performance. This network performance related data can include information about radio coverage area, cell boundaries, coverage holes in the cell, and user activity of the cell, as examples. The OSS 117 can use this received network performance data to maintain and configure network components, as well as manage faults and provision services for an improved overall quality of service (QoS). However, as shown in FIG. 1B, when the DAS 102 is connected to base station 108(1)-108(P) in a cellular network, each remote unit 104(1)-104(N) is connected to the same cell transceiver 118(1)-118(P) of the base stations 108(1)-108(P), where ‘P’ is the number of base stations. This is because the service router 120 in a head-end unit 122 in the central unit 106 splits the received downlink communications signals 110D to be distributed to multiple remote units 104(1)-104(N). Thus, a coverage area 124(1) of cell transceiver 118(1), for example, encompasses more than one remote coverage area 100(1), 100(2) in the example in FIG. 1B. However, each remote unit 104(1)-104(N) has its own remote coverage area 100(1)-100(N) that can have distinct and varying performance from other coverage areas. Thus, performance of multiple remote coverage areas 100(1)-100(N) in the DAS 102 in FIG. 1B is treated as one coverage area along with the cell transceiver 118 at a respective base station 108.

It may be desired to determine and report performance data on individual remote coverage areas 100(1)-100(N) of the remote units 104(1)-104(N) in the DAS 102 in FIGS. 1A and 1B to provide optimizations for the DAS 102 to improve quality of service (QoS). As examples, DAS optimizations could include adding more remote coverage areas for enhanced coverage or to alleviate overloading of remote units, and increasing or changing transmission power for higher signal quality and/or balancing of remote coverage areas.

No admission is made that any reference cited herein constitutes prior art. Applicant expressly reserves the right to challenge the accuracy and pertinency of any cited documents.

### SUMMARY

Embodiments disclosed herein include evaluating performance of remote units on a per remote unit basis in a distributed antenna system (DAS). Related devices, methods, and DASs are also disclosed. From a cellular network perspective, because each remote unit in a DAS is connected to the same cell transceiver of a base station, the individual remote coverage areas in the DAS are treated as one coverage area with the cell of the connected base station. In this regard, in certain aspects provided herein, at least one performance indicator regarding the remote units in the DAS is determined on a per remote unit basis in the DAS, since each remote unit has its own remote coverage area that can have distinct and varying performance from other coverage areas in the DAS. The performance indicator(s) determined for each remote unit, on a per remote unit basis, can be communicated to a network or other system that is configured to analyze the performance related information and/or determine optimizations for the DAS to improve quality of service (QoS).

In certain embodiments, the performance indicators determined about the remote units are based on receiving downlink communications signals communicated to and/or uplink communications signals received by the remote units. The received communication signals are analyzed to determine performance information or data about performance factors that is directly or indirectly an indication of performance of the remote units in the DAS. The performance information determined for each remote unit is used to determine one or more performance indicators for each remote unit. Non-limiting examples of performance indicators for remote units include its total uplink received power or uplink received power, uplink communications signal quality, traffic load, signaling load, the number of user equipment that remote unit receives communications signals in its coverage area, and intensity of cellular activity. In response, optimizations can be carried out in the remote units in the DAS and can be adjusted based on the performance related information.

For example, as a non-limiting example, downlink communications signal power may be increased to change the coverage area of a remote unit(s) or decreased to reduce signal interference. As another example, a remote unit that is determined to not have adequate load or traffic can be decommissioned to conserve power or reduce interference with other remote coverage areas in the DAS. As yet another example, additional remote units can be added to the DAS to increase communications capacity. As yet another non-limiting example, antennas of the remote units may be adjusted to adjust the remote coverage areas. As yet another non-limiting example, offloading techniques, such as WiFi offloading, may be employed when traffic load is high in particular remote units in the DAS. As yet another example, specific remote units which have either no signaling load or traffic, or not sufficient signaling load or traffic in downlink path or uplink path can be turned off or deactivated, or their uplink path gain decreased, to reduce or mitigate uplink interference.

One embodiment of the disclosure relates to a performance evaluation system for evaluating performance of remote units in a distributed antenna system (DAS). The performance evaluation system comprises a receiver system. The receiver system comprises a plurality of signal inputs each configured to receive communications signals from a remote unit among a plurality of remote units in a DAS. The receiver system also comprises an analysis circuit. The analysis circuit is configured to analyze the received communications signals for each remote unit among the plurality of remote units to determine performance information for a corresponding remote unit among the plurality of remote units. The analysis circuit is also configured to provide a plurality of output signals each corresponding to a remote unit among the plurality of remote units, the plurality of output signals each comprising performance information for the corresponding remote unit among the plurality of remote units. The performance evaluation system also comprises a performance analysis unit. The performance analysis unit is configured to receive the plurality of output signals from the receiver system. The performance analysis unit is also configured to, for each remote unit, determine a performance indicator indicative of performance of the remote unit based on a received output signal among the plurality of output signals corresponding to the remote unit.

Another embodiment of the disclosure relates to a method of evaluating performance of remote units in a DAS. The method comprises receiving communications signals from a remote unit among a plurality of remote units in a DAS. The method also comprises analyzing the received communications signals for each remote unit among the plurality of remote units to determine performance information for a corresponding remote unit among the plurality of remote units. The method also comprises, for each remote unit, determining a performance indicator indicative of performance of the remote unit based on a received output signal among a plurality of output signals corresponding to the remote unit.

Another embodiment of the disclosure relates to a DAS. The DAS comprises a central unit. The central unit is configured to receive downlink communications signals and distribute the received downlink communications signals over a downlink communications medium to a plurality of remote units. The central unit is also configured to receive uplink communications signals over an uplink communications medium from the plurality of remote units and distribute the received uplink communications signals to a network. Each remote unit among the plurality of remote units is configured to receive the downlink communications signals over the downlink communications medium from the central unit and distribute the received downlink communications signals to user equipment. Each remote unit among the plurality of remote units is also configured to receive the uplink communications signals from the user equipment and distribute the received uplink communications signals over the uplink communications medium to the central unit. The DAS also comprises a performance evaluation system. The performance evaluation system is configured to receive communications signals from a remote unit among a plurality of remote units in a DAS. The performance evaluation system is also configured to analyze the received communications signals for each remote unit among the plurality of remote units to determine performance information for a corresponding remote unit among the plurality of remote units. For each remote unit, the performance evaluation system is also configured to determine a performance indicator indicative of performance of the remote unit based on a received output signal among a plurality of output signals corresponding to the remote unit.

Additional features and advantages will be set forth in the detailed description which follows, and in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification.

### BRIEF DESCRIPTION OF THE DRAWINGS

FIGS. 1A and 1B are schematic diagrams of an exemplary distributed antenna system (DAS) capable of distributing radio-frequency (RF) communications services to user equipment;

FIG. 2 is a schematic diagram of another exemplary DAS wherein performance indicators are determined for the remote units in the DAS on a per remote unit basis employing a combined receiver to be communicated to another network or system for determining optimizations for the DAS;

FIG. 3 is a flowchart illustrating an exemplary process of receiving communications signals from remote units in the DAS in FIG. 2 on a per remote unit basis, and analyzing the received communications signals to determine one or more performance indicators about the remote units, to be communicated to another network or system for determining optimizations for the DAS;

FIG. 4 is a schematic diagram of another exemplary DAS wherein performance indicators are determined for the remote units in the DAS on a per remote unit basis employing separate receivers for the remote units to be communicated to another network or system for determining optimizations for the DAS;

FIG. 5A is schematic diagram illustrating uplink power received in uplink communications signals by each remote unit in the DAS in FIG. 2 or FIG. 4 from user equipment in the remote coverage areas, which can be used as a performance indicator indicative of performance of the remote units in the DAS;

FIG. 5B is graph illustrating the total received signal strength indicator (RSSI) of received uplink communications signals by each remote unit in the DAS in FIG. 5A, which can be used as a performance indicator indicative of performance of the remote units in the DAS;

FIG. 6A is a table illustrating exemplary performance indicators that can be determined to determine performance of remote units in a DAS based on certain performance information obtained from analysis of non-decoded received uplink communications signals;

FIG. 6B is a table illustrating exemplary performance indicators that can be determined to determine performance of remote units in a DAS based on certain performance information obtained from analysis of decoded received uplink communications signals;

FIG. 7A illustrates an exemplary long term evolution (LTE) radio frame structure to illustrate resource blocks and elements for LTE communication signals that can be decoded and analyzed to determine a performance indicator(s) about a remote unit in DAS;

FIG. 7B illustrates an exemplary sub-frame for a LTE radio frame illustrating control channel resource blocks contained therein;

FIG. 8 is schematic diagram illustrating uplink power received in uplink communications signals by remote units that can be provided in the DAS in FIG. 2 or FIG. 4, from user equipment in the remote coverage areas used as a performance indicator indicative of performance of the remote units in the DAS, and certain remote units employing beamforming techniques for transmission of downlink communications signals based on the determined performance of the remote units in the DAS;

FIG. 9 is a schematic diagram of exemplary optical fiber-based DAS wherein performance indicators are determined for the remote units in the DAS on a per remote unit basis to be communicated to another network or system for determining optimizations for the DAS;

FIG. 10 is a partially schematic cut-away diagram of an exemplary building infrastructure in which a DAS configured to collect performance related information regarding the remote units on a per remote unit basis, and analyze the performance related information to be communicated to another network or system for determining optimizations for the DAS can be employed; and

FIG. 11 is a schematic diagram of a generalized representation of an exemplary controller that can be included in any central unit, remote units, receiver, and/or performance evaluation unit in a DAS to collect performance related information regarding the remote units on a per remote unit basis and/or analyze the performance related information to be communicated to another network or system for determining optimizations for the DAS, wherein the exemplary computer system is adapted to execute instructions from an exemplary computer readable medium.

### DETAILED DESCRIPTION

Various embodiments will be further clarified by the following examples.

Embodiments disclosed herein include evaluating performance of remote units on a per remote unit basis in a distributed antenna system (DAS). Related devices, methods, and DASs are also disclosed. From a cellular network perspective, because each remote unit in a DAS is connected to the same cell transceiver of a base station, the individual remote coverage areas in the DAS are treated as one coverage area with the cell of the connected base station. In this regard, in certain aspects provided herein, at least one performance indicator regarding the remote units in the DAS is determined on a per remote unit basis in the DAS, since each remote unit has its own remote coverage area that can have distinct and varying performance from other coverage areas in the DAS. The performance indicator(s) determined for each remote unit, on a per remote unit basis, can be communicated to a network or other system that is configured to analyze the performance related information and/or determine optimizations for the DAS to improve quality of service (QoS).

In certain embodiments, the performance indicators determined about the remote units are based on receiving downlink communications signals communicated to and/or uplink communications signals received by the remote units. The received communication signals are analyzed to determine performance information or data about performance factors that is directly or indirectly an indication of performance of the remote units in the DAS. The performance information determined for each remote unit is used to determine one or more performance indicators for each remote unit. Non-limiting examples of performance indicators for remote units include its total uplink received power or uplink received power, uplink communications signal quality, traffic load, signaling load, the number of user equipment that remote unit receives communications signals in its coverage area, and intensity of cellular activity. In response, optimizations can be carried out in the remote units in the DAS and can be adjusted based on the performance related information. For example, as a non-limiting example, downlink communications signal power may be increased to change the coverage area of a remote unit(s) or decreased to reduce signal interference. As another example, a remote unit that is determined to not have adequate load or traffic can be decommissioned to conserve power or reduce interference with other remote coverage areas in the DAS. As yet another example, additional remote units can be added to the DAS to increase communications capacity. As yet another non-limiting example, antennas of the remote units may be adjusted to adjust the remote coverage areas. As yet another non-limiting example, offloading techniques, such as WiFi offloading, may be employed when traffic load is high in particular remote units in the DAS. As yet another example, specific remote units which have either no signaling load or traffic, or not sufficient signaling load or traffic in downlink path or uplink path can be turned off or deactivated, or their uplink path gain decreased, to reduce or mitigate uplink interference.

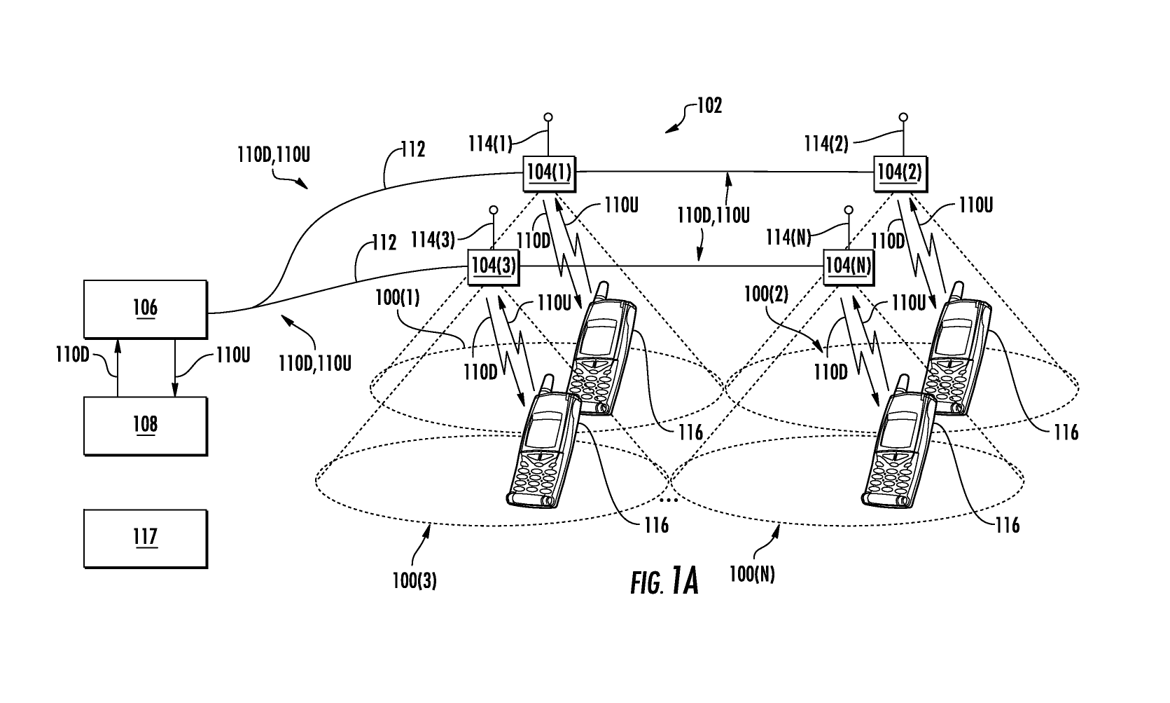

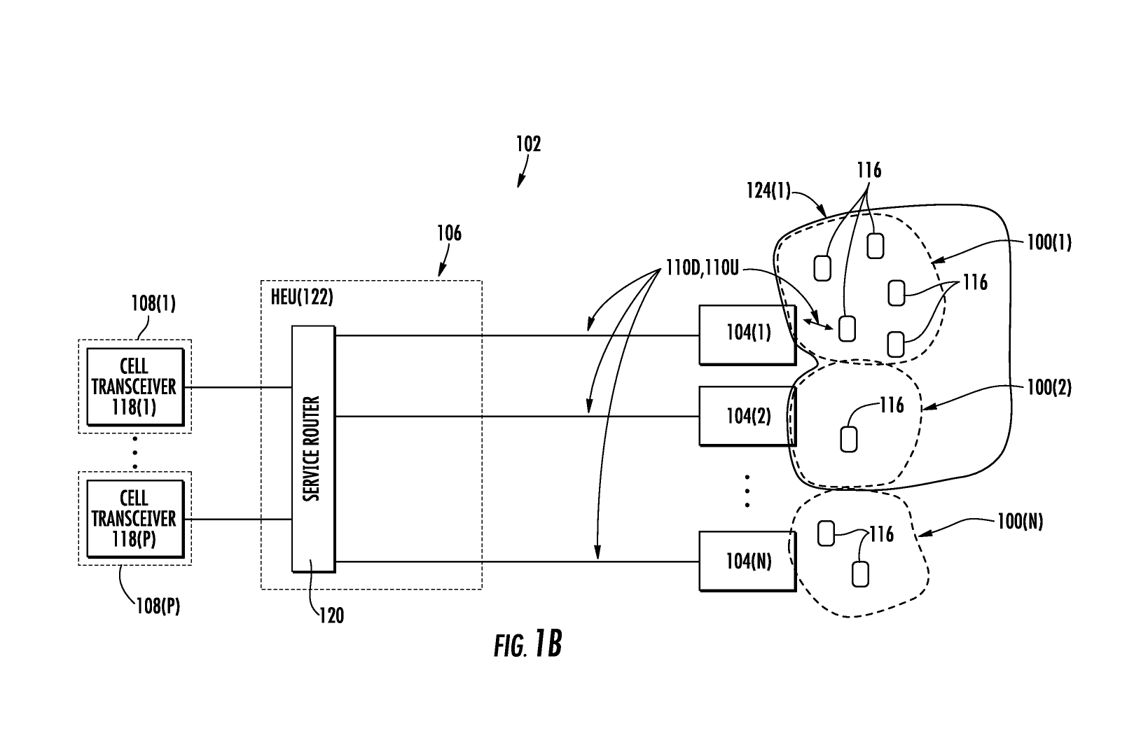

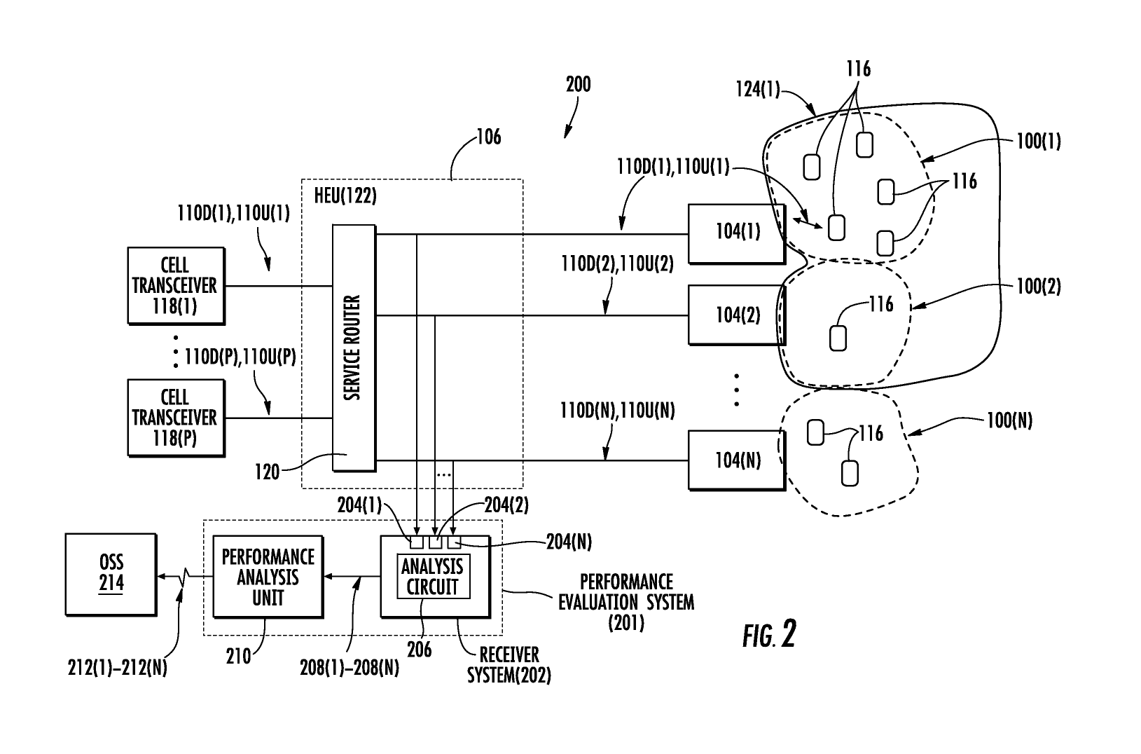

In this regard, FIG. 2 is a schematic diagram of exemplary DAS 200 wherein performance indicators are determined for the remote units 104(1)-104(N) on a per remote unit basis to be communicated to another network or system for determining optimizations for the DAS 200. In this regard, common elements between the DAS 102 in FIGS. 1A and 1B and the DAS 200 in FIG. 2 are shown with common element numbers, and thus will not be re-described. The exemplary operation of the components in the DAS 200 in FIG. 2 for determining performance indicators for the remote units 104(1)-104(N) on a per remote unit basis is described below with reference to the exemplary process 300 in FIG. 3.

In the DAS 200 in FIG. 2, to determine performance indicators for the remote units 104(1)-104(N) on a per remote unit basis, a performance evaluation system 201 is provided. In this example, performance evaluation system 201 includes a receiver system 202. The receiver system 202 comprises a plurality of signal inputs 204(1)-204(N) each configured to receive the uplink communications signals 110U(1)-110U(N) from respective the remote units 104(1)-104(N) in the DAS 200 (block 302 in FIG. 3). The receiver system 202 could be located within the head end unit 122 or outside of the head end unit 122, as shown in FIG. 2. Information about the uplink communications signals 110U(1)-110U(N) can be used to determine performance information about the respective remote units 104(1)-104(N). Thus in this example, the receiver system 202 includes an analysis circuit 206. The analysis circuit 206 is configured to analyze the received uplink communications signals 110U(1)-110U(N) for each remote unit 104 among the plurality of remote units 104(1)-104(N) to determine performance information for the remote units 104(1)-104(N) (block 304 in FIG. 3).

Examples of analyzing the received uplink communications signals 110U(1)-110U(N) to determine performance information for the remote units 104(1)-104(N) are described in more detail below. Such examples include both analysis of the uplink communications signals 110U(1)-110U(N) in both decoded and undecoded form. For example, if the receiver system 202 is configured to analyze performance information of received downlink or uplink communication signals 110D, 110U based on information encoded in the downlink or uplink communication signals 110D, 110U, the receiver system 202 can be configured to decode the received downlink or uplink communication signals 110D, 110U. The analysis circuit 206 can be configured to analyze the decoded information contained in the downlink or uplink communication signals 110D, 110U to determine performance information for the remote unit 104(1)-104(N). For example, decoding can mean decoding the downlink communications signals 110D or uplink communications signals 110U to analyze information contained therein. For example, decoding may include decoding control information in the downlink communications signals 110D or uplink communications signals 110U can be decoded to determine the allocation of air interface resources (e.g. in LTE—resource blocks). Alternatively, as discussed in more detail below, the analysis circuit 206 can be configured to measure the uplink received power without decoding information for evaluation of the remote unit 104(1)-104(N) performances.

With continuing reference to FIG. 2, the receiver system 202 is configured to provide a plurality of output signals 208(1)-208(N) each corresponding to a remote unit 104 among the plurality of remote units 104(1)-104(N) to a performance analysis unit 210 also provided in the performance evaluation system 201 in this example. The output signals 208(1)-208(N) each include performance information for the corresponding remote unit 104(1)-104(N). The performance analysis unit 210 is configured to receive the plurality of output signals 208(1)-208(N) from the receiver system 202. The performance analysis unit 210 is also configured to determine a performance indicator(s) indicative of performance of each remote unit 104(1)-104(N) based on output signals 208(1)-208(N) corresponding to the remote units 104(1)-104(N) (block 306 in FIG. 3). The performance analysis unit 210 is then configured to communicate the performance indicators in performance indicator signals 212(1)-212(N) for the remote units 104(1)-104(N) to another system to be reviewed and/or analyzed to perform optimizations in the DAS 200. For example, the performance indicator signals 212(1)-212(N) may be communicated to a base station communicatively coupled to the DAS 200. The performance indicator signals 212(1)-212(N) may be communicated directly or indirectly from the performance analysis unit 210 to an operational and support system (OSS) 214 (or any other system, e.g., an Operational and Management (OA&M) system) to be used to report the performance of the remote coverage areas 100(1)-100(N) in the DAS 200 and/or to determine optimizations for the DAS 200.

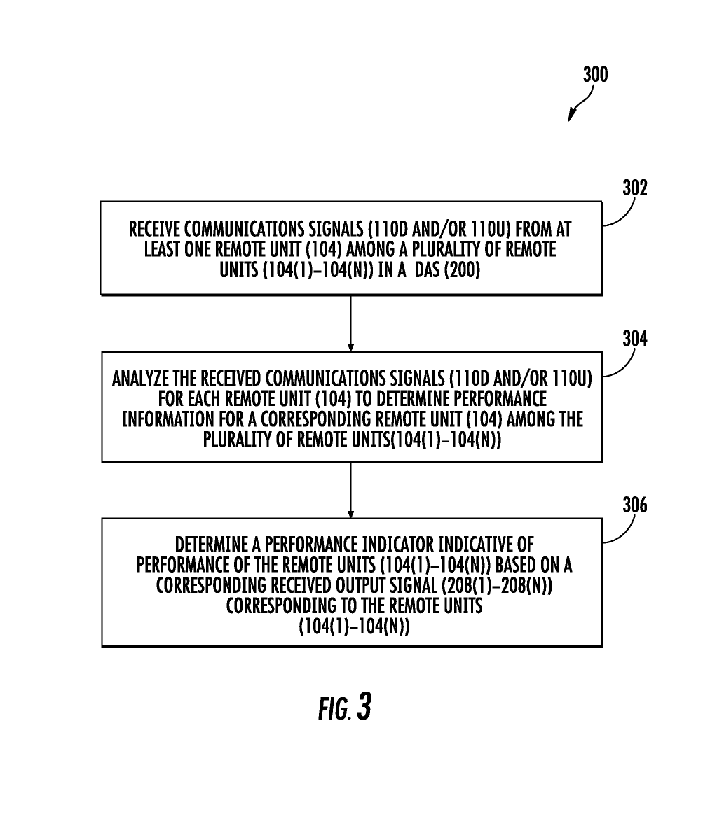

Note that although the DAS 200 in FIG. 2 shows the receiver system 202 as a single receiver, the receiver system 202 could include individual receivers each dedicated to receive uplink communications signals 110U(1)-110U(N). In this regard, FIG. 4 illustrates a DAS 200′ that is similar to the DAS 200 in FIG. 2. However, as shown therein, a performance evaluation system 201′ is provided that includes a receiver system 202′ which includes separate individual receivers 216(1)-216(N) provided in the head end unit 122 to receive uplink communications signals 110U(1)-110U(N) from the respective remote units 104(1)104(N). Just as discussed above in FIG. 2, an analysis circuit 206(1)-206(N) may be provided in each receiver 216(1)-216(N) to analyze the respective received uplink communications signals 110U(1)-110U(N) for the remote units 104(1)-104(N) to determine performance information for the remote units 104(1)-104(N). The receivers 216(1)-216(N) in the receiver system 202′ are configured to provide a plurality of output signals 208(1)-208(N) each corresponding to a remote unit 104 among the plurality of remote units 104(1)-104(N) to the performance analysis unit 210, like included in the DAS 200 in FIG. 2. As discussed above, the performance analysis unit 210 in the performance evaluation system 201 determines a performance indicator(s) indicative of performance of each remote unit 104(1)-104(N) and communicates the performance indicator signals 212(1)-212(N) for the remote units 104(1)-104(N) to another system to be reviewed and/or analyzed to perform optimizations in the DAS 200.

There are many ways that performance indicators regarding the performance of remote units in a DAS, such as remote units 104(1)-104(N) in the DASs 200 and 200′ in FIGS. 2 and 4 can be determined. For example, it may be desired to determine performance indicators based on power of uplink communications signals received from user equipment in the communication range of a remote unit as performance information. The determined power may be absolute total received power or relative (i.e., differentiated) power relative to the received total power by other remote units in a DAS. For example, a determination of received power by a remote unit can be used to determine remote unit performance, such as traffic loading, number of user equipment communicating to the remote unit, signaling load, cellular activity, and signal reception quality. For example, determining that a remote unit is receiving uplink communications signals totaling a higher power level as performance information can be an indication that a traffic overload condition exists whereby adding an additional remote unit(s) may increase performance. A determined lower total power as performance information may be an indication of a lower traffic load. For example, a remote unit could be deinstalled or moved to another remote coverage area in a DAS if certain remote units experience a lower traffic load for sustained periods of time. Analyzing the power of received communications signals by a remote unit can also be used to determine signal quality as performance information. Signal quality performance information can be an indication of the existence of interferences in the remote unit as a performance indicator. One measure of total received power is a received signal strength indicator (RSSI). RSSI is a relative signal strength measurement of the power present in a received radio signal. As an another example, an evaluation of RSSI (or power) ratio between the received signaling resource blocks (RB) power and traffic resource blocks power of uplink signals could be used as a performance information for evaluation of radio coverage quality or radio coverage strength of remote units.

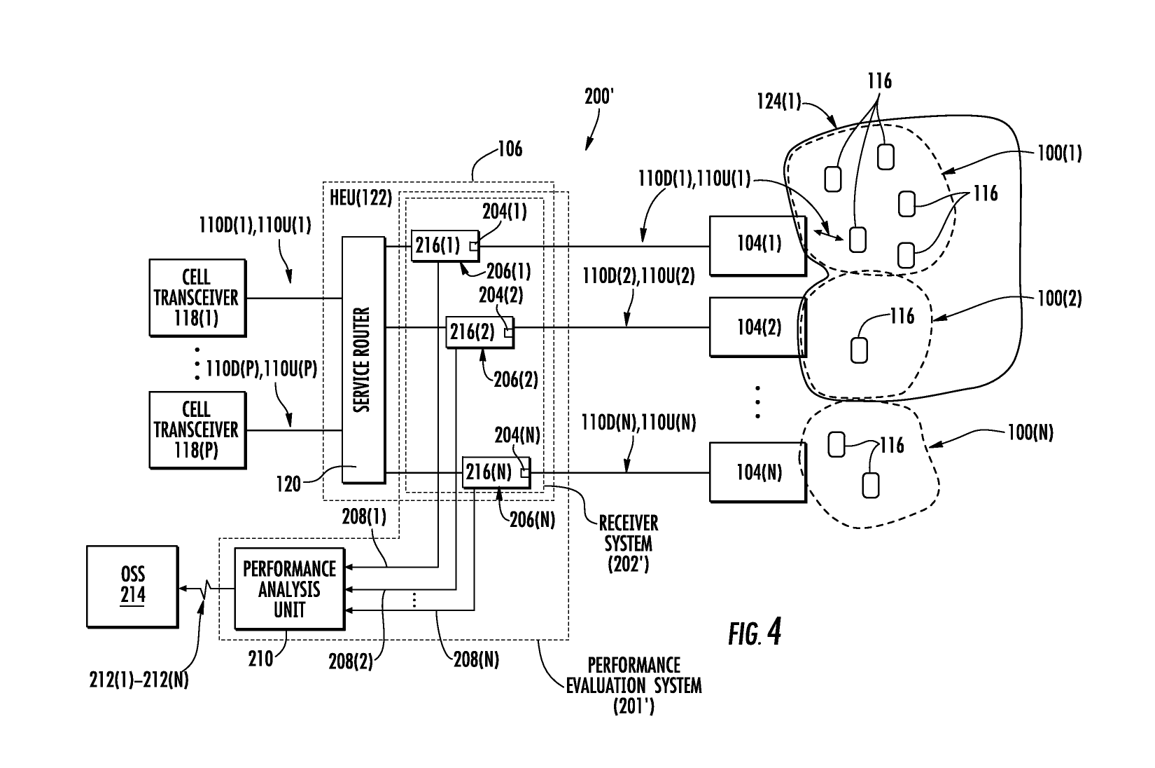

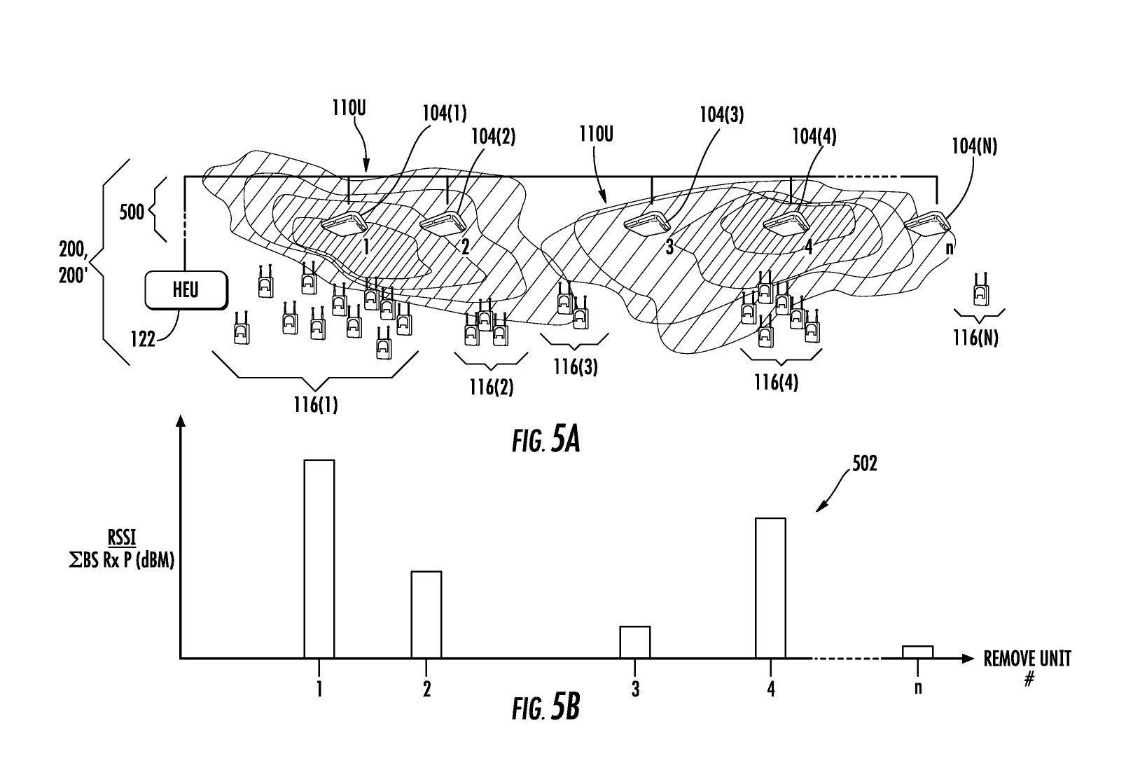

In this regard, FIG. 5A is schematic diagram illustrating uplink power 500 received in uplink communications signals 110U by remote unit 104(1)-104(N) in the DAS 200, 200′ in FIG. 2 or FIG. 4 from user equipment 116 in the remote coverage areas 100(1)-100(N) (see FIGS. 2 and 4). As illustrated therein, the remote units 104(1)-104(N) received uplink communications signals 110U from user equipment 116. The user equipment 116 is shown is groupings of user equipment 116(1)-116(N) based on the number of user equipment 116 present in the communication range of the remote units 104(1)-104(N). Usually, the greater number of user equipment transmitting uplink communications signals 110U in a remote coverage area 100(1)-100(N), the greater the total received power in uplink communications signals 110U by a remote unit 104(1)-104(N) providing the respective remote coverage areas 100(1)-100(N). In this regard, FIG. 5B is graph 502 illustrating the RSSI for each remote unit 104(1)-104(N) based on the power in the received uplink communications signals 110U by each remote unit 104(1)-104(N) in the DAS 200, 200′ in FIG. 5A. As shown in FIG. 5B, the RSSI is higher for remote unit 104(1) than remote unit 104(2), because a greater number of user equipment 116(1) is communicating uplink communications signals 110U to remote unit 104(1) than remote unit 104(2). However, while a greater number of user equipment 116 communicating uplink communications signals 110U to a particular remote unit 104 increases received power in the remote unit 104, a remote unit 104 receiving more uplink communications signals 110U than another remote unit 104 may still have a greater RSSI depending on the power level in the particular uplink communications signals 110U communicated to the remote unit 104.

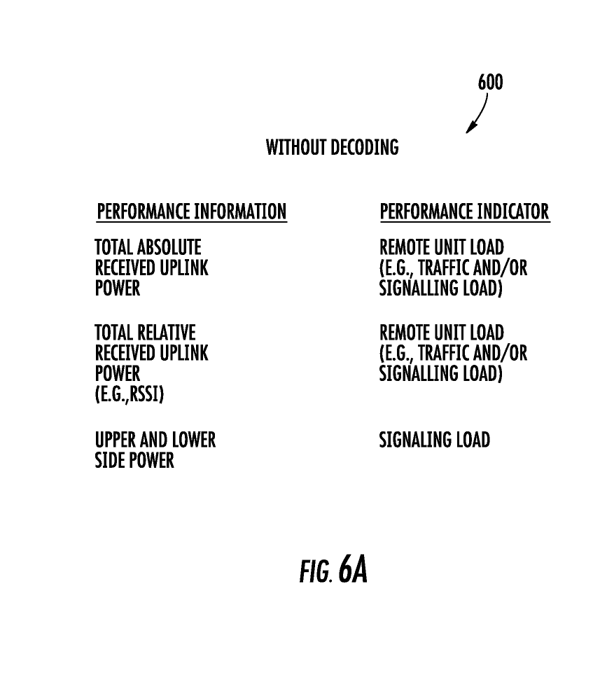

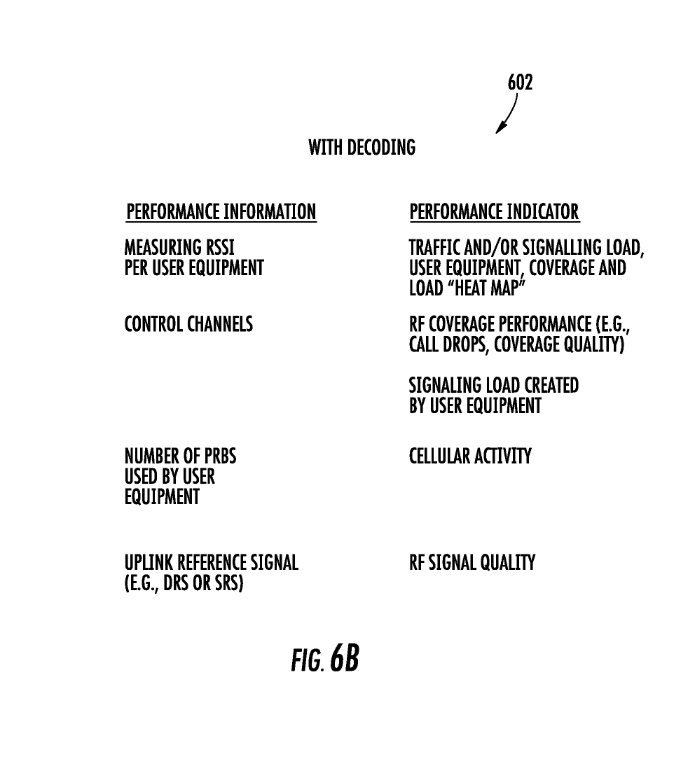

FIG. 6A is a table 600 illustrating exemplary performance indicators that can be determined to determine performance of remote units in a DAS based on certain performance information obtained from analysis of non-decoded received uplink communications signals. Analysis of non-decoded received uplink communications signals in a remote unit has the advantage of an analysis circuit not having to be configured to decode signals and recognize different communications protocols. However, analysis of the received uplink communications signals cannot provide certain types of information embedded in the received uplink communications signals according to the communications protocol employed for the received uplink communications signals. As one example, total absolute received uplink power in a remote unit can be used as an indirect method to determine remote unit load, which can include traffic and/or signalling load of the remote unit. The greater the received uplink power in a remote unit, usually, the greater number bandwidth of the received uplink communications signals. As another example, relative received uplink power (e.g., RSSI) in a remote unit can be used as an indirect method to determine remote unit load, which can include traffic and/or signaling load of a remote unit. As another example, signaling load can be used as a method of determining load of a remote unit, because the greater the signaling load, the greater the signaling overhead is involved in establishing or maintaining connections and disconnections of user equipment, thereby decreasing performance of the remote unit. If the received uplink communications signal is not decoded, the upper and lower side power of the received uplink communications signals by a remote unit can also be used as an indirect method of determining signaling load of a remote unit. For example, total absolute power of the two (2) first and last RBs may be used as an indicator of signaling control load when no sufficient traffic load exists.

As discussed above, more direct performance information may be determined from communications signals received by a remote unit if the received communications signals are decoded and analyzed. This is because many communications protocols involve encoding information related to communications performance. In this regard, FIG. 6B is a table 602 illustrating exemplary performance indicators that can be determined to determine performance of remote units in a DAS based on certain performance information obtained from analysis of decoded received uplink communications signals. For example, the received uplink communications signals by a remote unit could to measure RSSI for each UE to determine the traffic and/or signaling load of the remote unit, the UE locations and/or the remote unit load “heat map,” like shown in FIGS. 5A and/or 5B. In this manner, the signaling load created by the user equipment on the remote unit can be determined as a performance indicator. As another example, received downlink and/or uplink communications signals in a remote unit can be decoded to analyze the downlink, uplink, and/or control channels. The downlink, uplink, and/or control channels will be identified explicitly for each user equipment. This method enables obtaining more accurate information regarding each user equipment uplink transmission to determine RF coverage performances by the remote unit (e.g., call drops, poor or good coverage area, etc.). As another example, the downlink and/or uplink communications signals in a remote unit can be decoded to analyze the number of Physical Resource Blocks (PRBs) used by the user equipment in the remote coverage area of a remote unit. This provides a combined indication for the intensity of the cellular activity in terms of number of active user equipment communicating to the remote unit and/or the amount of data the user equipment transmits in the uplink communications signals. As another example, uplink reference signals (RS) of a received communications signal can be used to determine received communications signal quality as a performance indicator. For this example, the RS power received by two or more remote units could be compared to analyze cellular activity per remote units.

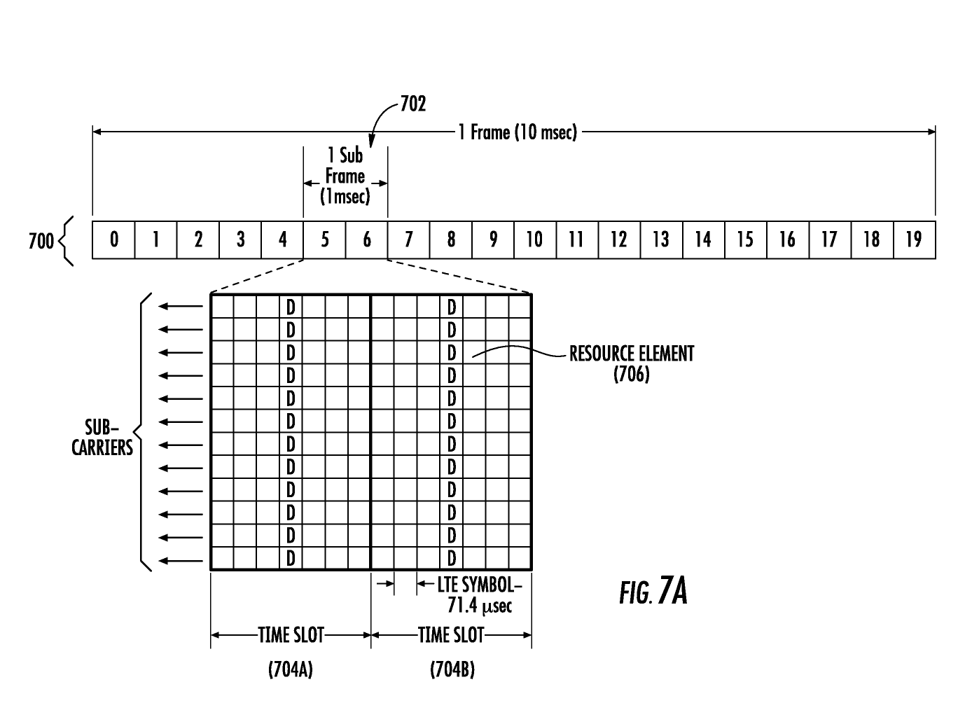

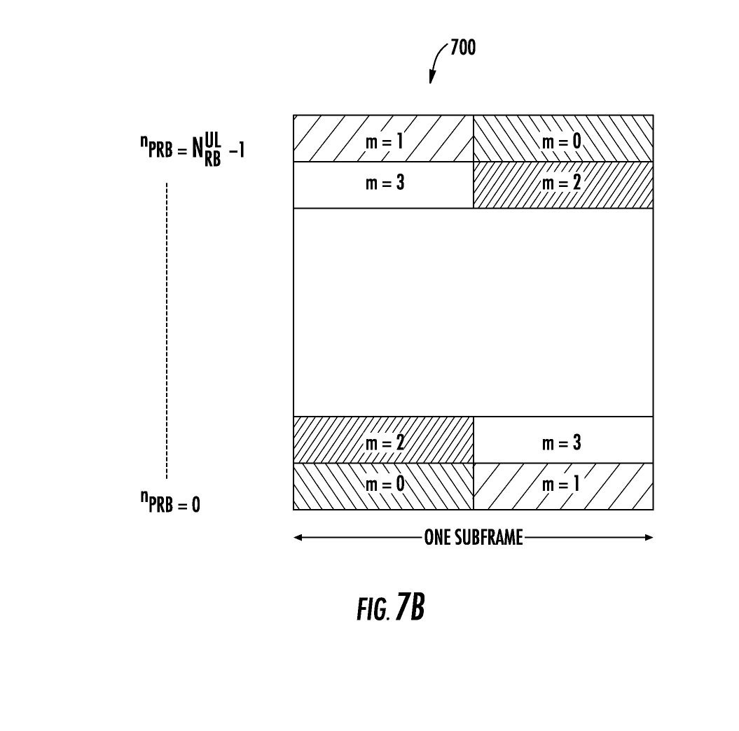

There are a number of options and optimizations that may be performed in a DAS based on receiving the performance information about remote units in the DAS on a per remote unit basis. For example, if signaling and/or traffic load of a remote unit is below expectations, the downlink communications signal power (i.e., gain) can be increased on a per remote unit basis to change or increase the remote coverage area. Downlink communications signal power (i.e., gain) could also be decreased on a per remote unit basis to decrease the remote coverage area in response to the signaling and/or traffic load of a remote unit being below expectations. Alternatively, one or more channels and/or one or more communications services for the downlink communications signals could be shut down on a per remote unit basis in response to the determined traffic load for the one or more channels or one or more communications services being less than a threshold traffic load level. The downlink communications signal power can be decreased if it is determined that other nearby remote coverage areas are incurring more interference than desired. Also, if an adequate traffic or signaling load is not determined for a particular remote unit, the particular remote unit can be disabled or removed from the DAS to decrease power consumption, radiation, and/or interference. An enhanced node-B (eNB) may be dynamically modified in response. On the other hand, if signaling and/or traffic load of a remote unit is above expectations, the downlink communications signal power can be decreased to decrease the remote coverage area. If the signaling load is high relative to traffic load, the remote unit coverage could be optimized for better RF coverage. Or, this might be an indication of interference from other LTE base stations, such as outdoor macro base stations. In response, the desired optimization could be to increase remote unit transmission power, or decrease or tilt the macro base station. Also, additional remote units may be added to share the signaling and/or traffic load of user equipment in the DAS. Also, communications offloading techniques, such as WiFi loading, can be employed when traffic and/or signaling load of a remote unit is higher than desired. The antenna(s) of a remote unit can also be adjusted to increase or decrease reception range depending on the performance indicators determined for the remote unit. With regard to decoding communications signal to determine performance information about a remote unit, as an example, the communications protocol for communications signals transmitted by and received by the remote unit, may be a long term evolution (LTE) protocol. In this regard, FIG. 7A illustrates an exemplary LTE radio frame structure 700 to illustrate resource blocks and elements for LTE communications signals that can be decoded and analyzed to determine a performance indicator(s) about a remote unit in DAS. The LTE radio frame structure 700 can be applied for both frequency-division duplexing (FDD) and time-division duplexing (TDD) schemes. As illustrated in FIG. 7A, radio frames are transmitted continuously one after the other. The duration of one LTE radio frame 700 is ten (10) milliseconds (ms) in this example and consists of 10 sub-frames 702. The duration of one LTE subframe 702 is one (1) ms (TTI) and contains two (2) time slots 704A, 704B. The duration of each time slot 704A, 704B is 0.5 ms. Each time slot 704A, 704B contains six (6) or seven (7) LTE symbols with duration of 71.4 microseconds (μsec) in the case of seven (7) LTE symbols per time slot, and duration of 83.3 μsec in the case of six (6) LTE symbols per time slot. Each element of the LTE radio frame 700 also has a frequency dimension where the same structure of the LTE radio frame 700 simultaneously governs multiple subcarriers. The number of the subcarriers in the frequency domain depends on the bandwidth that the LTE base station is configured to use.

With continuing reference to FIG. 7A, a LTE resource element (RE) 706 is the smallest unit of radio resource and it is defined as the data carried by a single subcarrier for duration of a single LTE symbol. The downlink resource elements 706 at the downlink LTE radio frame may be used for carrying user data or signalization from the base station to the subscriber unit. The uplink resource elements 706 at the uplink radio frame may be used for carrying user data or signalization from the subscriber unit to the base station. A LTE “Resource Block” is defined as the data carried by twelve (12) subcarriers for a duration of a single LTE time slot (0.5 ms). The LTE resource block therefore supports carriers 12×7=84 resource elements 706 in the case where the time slot includes seven (7) LTE symbols, and carriers 12×6=72 resource elements 706 in the case where the time slot includes six (6) LTE symbols.

The analysis to determine performance information can be performed on the uplink radio frames, as either all allocated uplink physical resource blocks (PRB), just the uplink reference signals, or just some most upper and lowest resource blocks, as examples. User data in the uplink frames is allocated in multiples of two PRB in the Physical Uplink Shared Channel (PUSCH). Each uplink PRB includes special Reference Signals (RSs), called DM-RSs (Demodulation Reference Signals). The DM-RSs are used for channel estimation and enabling coherent demodulation. The DM-RSs are transmitted by the subscriber unit (UE) at the fourth LTE symbol of each time slot. For example, see FIG. 7A where the uplink DM-RSs are marked by ‘D.’ When no user data is transmitted, the LTE uplink time slot includes dedicated Physical Uplink Control Channel (PUCCH) used for signalization with associated uplink RS. The PUCCH is then mapped to a control channel resources in the uplink, as shown in FIG. 7B. In this case, PUCCH occupies PRBs at both edges of the uplink bandwidth.

With reference back to FIG. 7A, the data in a LTE radio frame 700 can be used as performance information to obtain performance indicators about a remote unit. For example, a receiver unit, such as receiver system 202 or 202′ in the DAS 200 or 200′ in FIG. 2 or 4 can receive uplink communications signals and measure the total received power or RSSI. According to this method, there is no need to decode the LTE communications signals, but only to measure the power contained in various elements of the LTE radio frame 700. The power measurement process can be synchronized (in terms of time) with the transmission of the uplink communications signals in order to be able to measure the required elements of the uplink radio frame transmission (uplink RSs, or PRBs, or altogether). For measuring the PUCCH, the receiver can be synchronized in frequency domain as well. As another example, at least part of the messages transferred between the user equipment and a cell transceiver using uplink communications signals transmission, and between the cell transceiver (e.g., base station) and the user equipment using downlink communications signal transmission can be decoded.

As one example of a performance indicator, cellular activity served by each remote unit (in terms of user data) provided in the uplink communications signal can be evaluated by measuring the absolute or relative power. The total received power can be per time slot or per sub frame 702 in the uplink communications signals. In remote units which serve higher uplink cellular activity (in terms of user data provided in the uplink), higher power will be measured. For overcoming measurement inaccuracies and reducing the impact of scenarios that might distort the measurements, data can be accumulated and averaged over relatively long periods (hours or even days). The measured power values can be mapped into a “heat map” for example, as shown in FIG. 5A, for indication of the relative cellular activity of the remote units. As previously discussed, FIG. 5A illustrates an example of different loads sharing remote units based on the total received uplink power of Demodulation Reference Signals (DM-RSs). Since each transmitted PRB includes DM-RSs in the fourth Symbol (or in the third symbol in case long cyclic prefix) on a LTE radio frame 700, the measured power of the DM-RSs provides a direct indication to the number of PRBs transmitted by the user equipment under the coverage area of the remote unit.

As another example, a performance indicator of a remote unit may be the signalization load created by user equipment under the coverage of a remote unit. High signalization load may be an indication for non-optimized network parameters related to channel access or handovers that might result in higher than normal dropped calls and hand off failures. High signaling load may be identified in the following ways. For example, when no user data is transmitted, the LTE uplink time slot in the LTE radio frame 700 in FIG. 7A includes dedicated PUCCH used for signalization. The total received power or RSSI of the PUCCH can be identified by detection of ZaddOff Chu sequence resource elements 706 in the fourth symbol of each time slot (0.5 msec) for PUSCH or combination of PUSCH and PUCCH, or PUCCH in uplink when PUSCH is not allocated. As another example, the messages provided in the downlink Control Channels (PDCCH) can be decoded to determine the allocation in uplink. These messages include various information such as an indication of resource elements 706 are allocated for uplink signaling or uplink traffic for each user equipment.

As another example, poor coverage or potential existence of RF interferences can be evaluated based on the Signal to Interference plus Noise Ratio (SINR). SINR can be obtained by measuring the total received power of all resource elements 706 per subframe in the LTE radio frame 700 in FIG. 7A, and comparing it to the power of the uplink DM-RS.

As another embodiment, some UEs with specific operating systems such as iOS or Android can provide reports which may include received power strength, power quality, and RSSI or other counters regarding received or transmitted communication signals. The UE may also be able to provide timing advance (TA) information that indicates the timing of when the UE will transmit uplink communications signals, as command by a base station during signaling procedures such as network entry or RACH (Random Access Channel) or during a communications session. In this regard, the UE could be configured to provide this information via wireless transmission, such as WiFi or Bluetooth (BT), via the cellular interface, or via the receivers 216(1)-215(N) to the performance analysis unit 210. It should be noted that the UE generated reports can be send via WiFi, BT, or cellular to the performance analysis unit 210 as well.

The performance analysis unit 210 in the performance evaluation system 201 can be configured to determine the location of the UE 116 in relation to the remote units 104(1)-104(N) to determine the applicability of the UE report to particular remote units 104(1)-104(N). For example, the TA information or RSSI level reported via each can be used to determine the location of the UE 116 relative to the remote units 104(1)-104(N). The UE reports can then be used as performance information regarding the received downlink communications signals 110D(1)-110D(N) by the UEs 116 from the remote units 104(1)-104(N) as performance indicators indicative of the downlink and/or uplink performance of the remote units 104(1)-104(N).

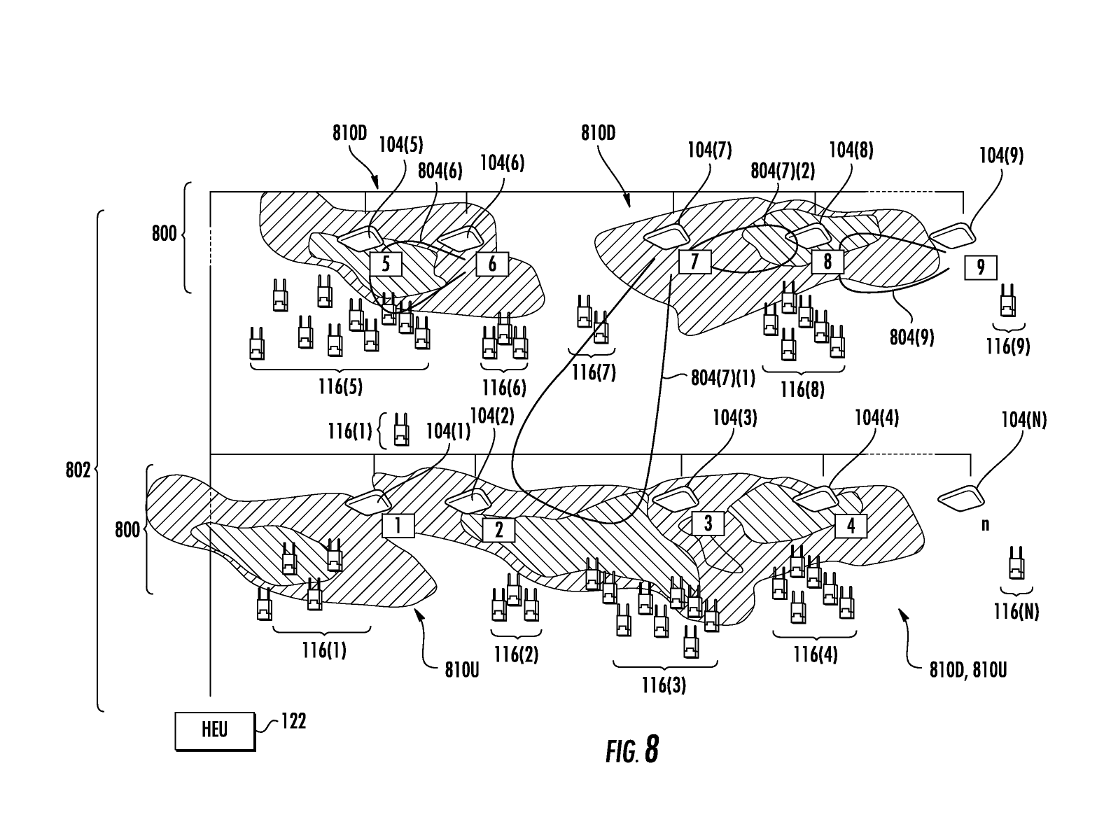

FIG. 8 is schematic diagram of another example of an optimization that may be performed in a DAS based on receiving the performance information about remote units in the DAS on a per remote unit basis. In this regard, FIG. 8 is a schematic diagram illustrating uplink power 800 received in uplink communications signals 810U by remote units 104(1)-104(N) in a DAS 802, which may be DAS 200, 200′ in FIG. 2 or FIG. 4 as examples, from user equipment 116 in the remote coverage areas 100(1)-100(N) (see FIGS. 2 and 4). As illustrated therein, the remote units 104(1)-104(N) received uplink communications signals 810U from user equipment 116. The user equipment 116 is shown as groupings of user equipment 116(1)-116(N) based on the number of user equipment 116 present in the communication range of the remote units 104(1)-104(N). Usually, the greater number of user equipment 116 transmitting uplink communications signals 810U in a remote coverage area 100(1)-100(N), the greater the total received power in uplink communications signals 810U by a remote unit 104(1)-104(N) providing the respective remote coverage areas 100(1)-100(N).

With continuing reference to FIG. 8, remote unit 104(5) for example is shown as having a higher RS SI (i.e., higher load) than remote unit 104(6), because a greater number of user equipment 116(5) is communicating uplink communications signals 810U to remote unit 104(5) than user equipment 116(6) is communicating uplink communications signals 810U to remote unit 104(6). As discussed above, the determined RSSI is one type of performance indicator that can be used to determine the performance of a remote unit. In this regard, as one possible optimization that may be performed for remote units 104(1)-104(N) having a higher RSSI or higher decreased performance indicator can cause other nearby or adjacent remote units to employ transmission beamforming to increase downlink communications signal 810D power transmitted to a remote unit 104(1)-104(N)—for example remote unit 104(5) in this example. This can increase the remote coverage area of remote unit 104(5). In this regard, in response to determining that the RSSI of remote unit 104(5) is higher than desired in this example, the DAS 802 can be configured to cause the remote unit 104(6) to employ beamforming to direct a portion of its downlink communications signals 810D (i.e., a portion of the power of downlink communications signal 810D) towards remote unit 104(5), as shown in FIG. 8. This may not impact the performance of remote unit 104(6) since there is a limited number of user equipment 116(6) communicating with remote unit 104(6) in this example. As another example, remote unit 104(7) in FIG. 8 is controlled to provide a beamformed transmission 804(7)(1) of its downlink communications signals 810D towards the remote coverage area between remote units 104(2) and 104(3) in response to the determined uplink power of remote unit 104(2) and 104(3) being higher than desired or expected. Remote unit 104(7) could also be controlled to beamform transmission of its downlink communications signals 810D in multiple directions, such as also providing beamformed transmission 804(7)(2) of its downlink communications signals 810D towards the area under remote unit 104(8), in response to the determined uplink power of remote unit 104(8) being higher than desired or expected. The area under remote unit 104(8) is also shown as receive beamforming transmissions 804(9), 804(7)(2) of the downlink communications signals 810D from multiple remote units 104, namely remote unit 104(9) and remote unit 104(7) in this example to increase the downlink communications signal 810D power transmitted to the area under remote unit 104(8).

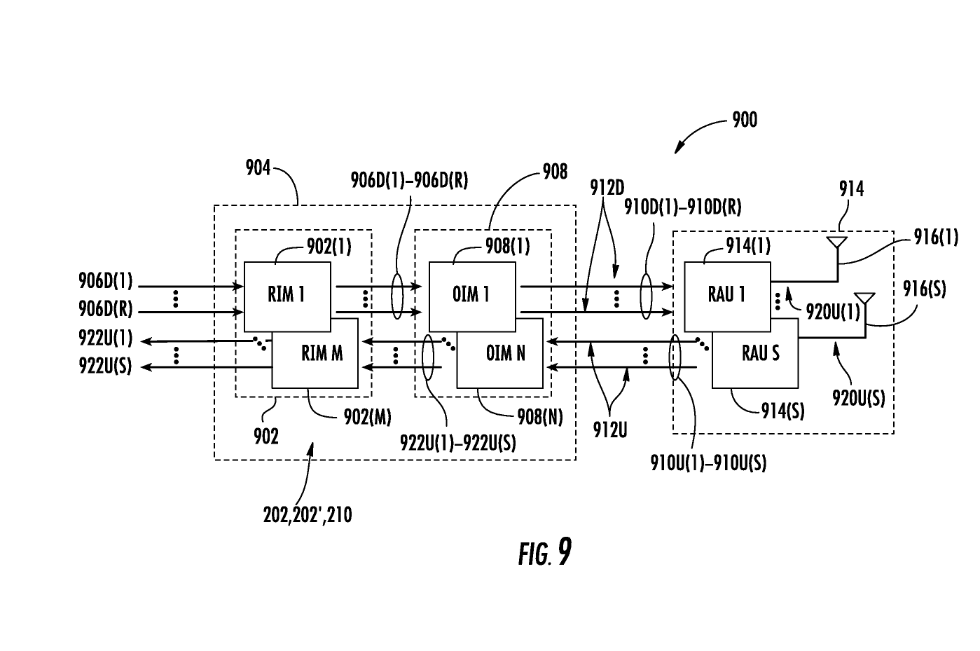

The components employed and disclosed above to evaluate the performance of remote units in a DAS on a per remote unit can be provided in different types of DAS. For example, FIG. 9 is a schematic diagram of an exemplary optical fiber-based DAS 900 that can be configured to collect performance related information regarding the remote units on a per remote unit basis, and analyze the performance related information to be communicated to another network or system for determining optimizations for the DAS. In this example, the DAS 900 includes optical fiber for distributing communications services. The receiver system 202, 202′ provided in the DASs 200, 200′ and/or the performance analysis unit 210 in FIGS. 2 and 4 above can be included in the DAS 900 to determine performance information about remote units and determine performance indicators about the remote units.

With continuing reference to FIG. 9, the DAS 900 in this example is comprised of three (3) main components. One or more radio interfaces provided in the form of radio interface modules (RIMs) 902(1)-902(M) are provided in a central unit 904 to receive and process downlink electrical communications signals 906D(1)-906D(R) prior to optical conversion into downlink optical communications signals. The downlink electrical communications signals 906D(1)-906D(R) may be received from a base station (not shown) as an example. The RIMs 902(1)-902(M) provide both downlink and uplink interfaces for signal processing. The notations “1-R” and “1-M” indicate that any number of the referenced component, 1-R and 1-M, respectively, may be provided.

With continuing reference to FIG. 9, the central unit 904 is configured to accept the plurality of RIMs 902(1)-902(M) as modular components that can easily be installed and removed or replaced in the central unit 904. In one embodiment, the central unit 904 is configured to support up to twelve (12) RIMs 902(1)-902(12). Each RIM 902(1)-902(M) can be designed to support a particular type of radio source or range of radio sources (i.e., frequencies) to provide flexibility in configuring the central unit 904 and the multi-frequency DAS 900 to support the desired radio sources. For example, one RIM 902 may be configured to support the Personal Communication Services (PCS) radio band. Another RIM 902 may be configured to support the 700 MHz radio band. In this example, by inclusion of these RIMs 902, the central unit 904 could be configured to support and distribute communications signals on both PCS and LTE 700 radio bands, as an example. RIMs 902 may be provided in the central unit 904 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). The RIMs 902(1)-902(M) may also be provided in the central unit 904 that support any wireless technologies desired, including but not limited to Code Division Multiple Access (CDMA), CDMA200, 1×RTT, Evolution-Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

The RIMs 902(1)-902(M) may be provided in the central unit 904 that support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

With continuing reference to FIG. 9, the downlink electrical communications signals 906D(1)-906D(R) are provided to a plurality of optical interfaces provided in the form of optical interface modules (OIMs) 908(1)-908(N) in this embodiment to convert the downlink electrical communications signals 906D(1)-906D(R) into downlink optical communications signals 910D(1)-910D(R). The OIMs 908 may be configured to provide one or more optical interface components (OICs) that contain optical-to-electrical (O/E) and electrical-to-optical (E/O) converters, as will be described in more detail below. The OIMs 908 support the radio bands that can be provided by the RIMs 902, including the examples previously described above.

The OIMs 908(1)-908(N) each include E/O converters to convert the downlink electrical communications signals 906D(1)-906D(R) into the downlink optical communications signals 910D(1)-910D(R). The downlink optical communications signals 910D(1)-910D(R) are communicated over downlink optical fiber communications medium 912D to a plurality of remote units 914(1)-914(S), which may be remote antenna units. The notation “1-S” indicates that any number of the referenced component 1-S may be provided. O/E converters provided in the remote units 914(1)-914(S) convert the downlink optical communications signals 910D(1)-910D(R) back into the downlink electrical communications signals 906D(1)-906D(R), which are provided to antennas 916(1)-916(S) in the remote units 914(1)-914(S) to user equipment (not shown) in the reception range of the antennas 916(1)-916(S).

E/O converters are also provided in the remote antenna units 914(1)-914(S) to convert uplink electrical communications signals 920U(1)-920U(S) received from user equipment (not shown) through the antennas 916(1)-916(S) into uplink optical communications signals 910U(1)-910U(S). The remote units 914(1)-914(S) communicate the uplink optical communications signals 910U(1)-910U(S) over an uplink optical fiber communications medium 912U to the OIMs 908(1)-908(N) in the central unit 904. The OIMs 908(1)-908(N) include O/E converters that convert the received uplink optical communications signals 910U(1)-910U(S) into uplink electrical communications signals 922U(1)-922U(S), which are processed by the RIMs 902(1)-902(M) and provided as uplink electrical communications signals 922U(1)-922U(S). The central unit 904 may provide the uplink electrical communications signals 922U(1)-922U(S) to a base station or other communications system.

Note that the downlink optical fiber communications medium 912D and uplink optical fiber communications medium 912U connected to each remote antenna unit 914(1)-914(S) may be a common optical fiber communications medium, wherein for example, wave division multiplexing (WDM) may be employed to provide the downlink optical communications signals 910D(1)-910D(R) and the uplink optical communications signals 910U(1)-910U(S) on the same optical fiber communications medium.

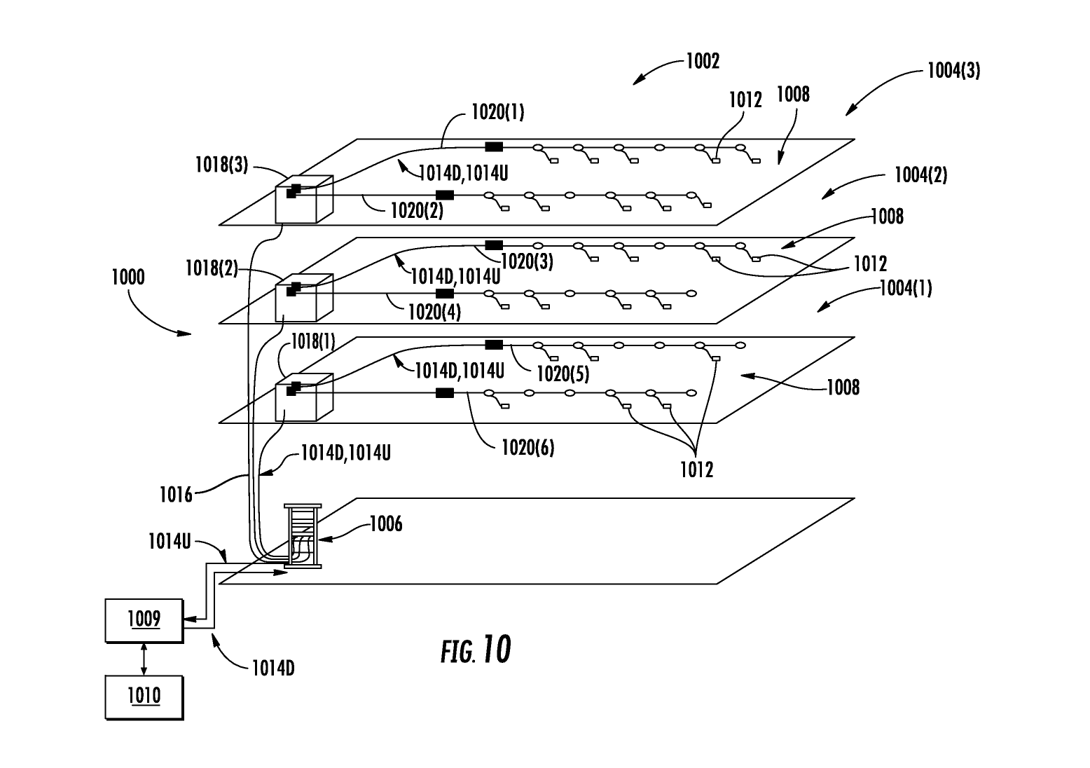

A DAS configured to collect performance related information regarding the remote units on a per remote unit basis, and analyze the performance related information to be communicated to another network or system for determining optimizations for the DAS, such as DAS 200 in FIG. 2, DAS 200′ in FIG. 4, and DAS 900 in FIG. 9, may be provided in an indoor environment, such as illustrated in FIG. 10. In this regard, FIG. 10 is a partially schematic cut-away diagram of a building infrastructure 1000 employing a DAS 1002 configured to evaluate performance of remote units on a per remote unit basis, as described above. The building infrastructure 1000 in this embodiment includes a first (ground) floor 1004(1), a second floor 1004(2), and a third floor 1004(3). The floors 1004(1)-1004(3) are serviced by the central unit 1006 to provide the antenna coverage areas 1008 in the building infrastructure 1000. The central unit 1006 is communicatively coupled to a base station 1009 to receive downlink communications signals 1014D from the base station 1009. The base station 1009 may be coupled to an operational and support system (OSS) 1010 to receive data about the performance of remote antenna units 1012 in the DAS 1002 on a per remote unit basis for determining DAS optimizations. The central unit 1006 is communicatively coupled to the remote antenna units 1012 to receive uplink communications signals 1014U from the remote antenna units 1012, similar to as previously discussed above for other DASs. The downlink and uplink communications signals 1014D, 1014U communicated between the central unit 1006 and the remote antenna units 1012 are carried over a riser cable 1016 in this example. The riser cable 1016 may be routed through interconnect units (ICUs) 1018(1)-1018(3) dedicated to each floor 1004(1)-1004(3) that route the downlink and uplink communications signals 1014D, 1014U to the remote antenna units 1012 and also provide power to the remote antenna units 1012 via array cables 1020(1)-1020(6).

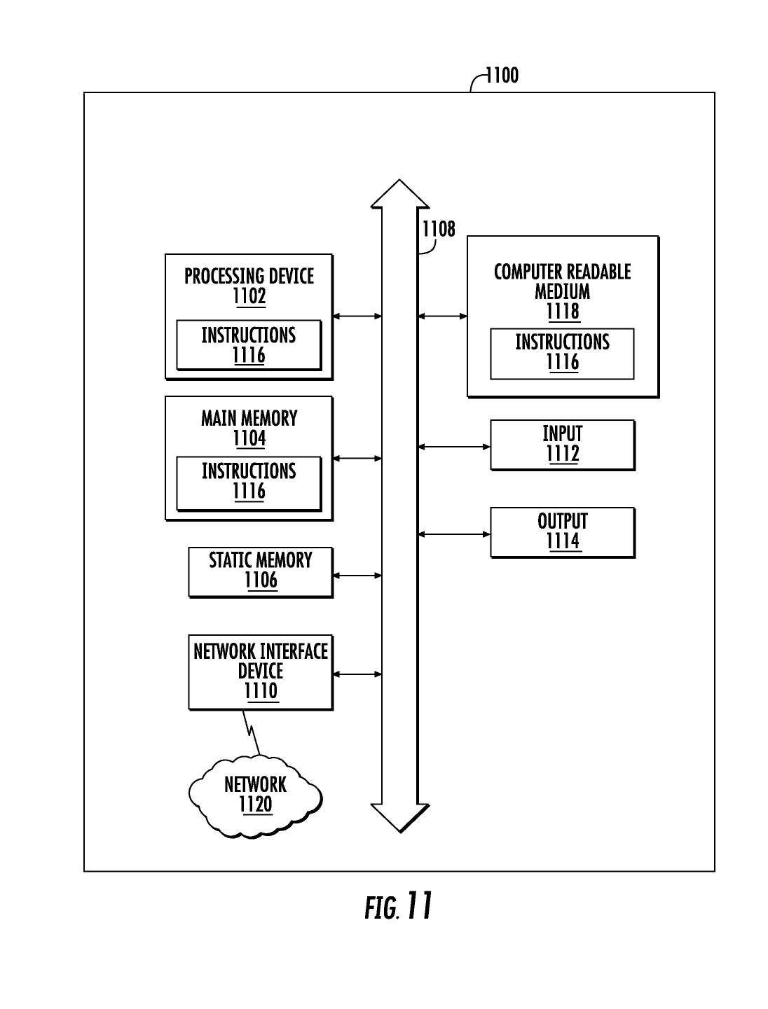

FIG. 11 is a schematic diagram representation of additional detail illustrating a computer system 1100 that could be employed in a receiver or a performance evaluation unit in a DAS, including those described above, for collecting performance related information regarding the remote units on a per remote unit basis and/or analyzing the performance related information to be communicated to another network or system. In this regard, the computer system 1100 is adapted to execute instructions from an exemplary computer-readable medium to perform these and/or any of the functions or processing described herein.

In this regard, the computer system 1100 in FIG. 11 may include a set of instructions that may be executed to predict frequency interference to avoid or reduce interference in a multi-frequency DAS. The computer system 1100 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 1100 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 1100 in this embodiment includes a processing device or processor 1102, a main memory 1104 (e.g., read-only memory (ROM), flash memory, dynamic random access memory (DRAM), such as synchronous DRAM (SDRAM), etc.), and a static memory 1106 (e.g., flash memory, static random access memory (SRAM), etc.), which may communicate with each other via a data bus 1108. Alternatively, the processor 1102 may be connected to the main memory 1104 and/or static memory 1106 directly or via some other connectivity means. The processor 1102 may be a controller, and the main memory 1104 or static memory 1106 may be any type of memory.

The processor 1102 represents one or more general-purpose processing devices, such as a microprocessor, central processing unit, or the like. More particularly, the processor 1102 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 1102 is configured to execute processing logic in instructions for performing the operations and steps discussed herein.

The computer system 1100 may further include a network interface device 1110. The computer system 1100 also may or may not include an input 1112, configured to receive input and selections to be communicated to the computer system 1100 when executing instructions. The computer system 1100 also may or may not include an output 1114, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1100 may or may not include a data storage device that includes instructions 1116 stored in a computer-readable medium 1118. The instructions 1116 may also reside, completely or at least partially, within the main memory 1104 and/or within the processor 1102 during execution thereof by the computer system 1100, the main memory 1104 and, the processor 1102 also constituting computer-readable medium. The instructions 1116 may further be transmitted or received over a network 1120 via the network interface device 1110.

While the computer-readable medium 1118 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention.

1. A performance evaluation system for evaluating performance of remote units in a distributed antenna system (DAS), comprising:
a receiver system, comprising:
a plurality of signal inputs each configured to receive communications signals from a remote unit among a plurality of remote units in a DAS; and
an analysis circuit configured to:
analyze the received communications signals for each remote unit among the plurality of remote units to determine performance information for a corresponding remote unit among the plurality of remote units; and
provide a plurality of output signals each corresponding to a remote unit among the plurality of remote units, the plurality of output signals each comprising performance information for the corresponding remote unit among the plurality of remote units; and
a performance analysis unit configured to:
receive the plurality of output signals from the receiver system; and
for each remote unit, determine a performance indicator indicative of performance of the remote unit based on a received output signal among the plurality of output signals corresponding to the remote unit.

2. The performance evaluation system of claim 1, wherein the receiver system is configured to not decode the received communications signals from each remote unit among the plurality of remote units.

3. The performance evaluation system of claim 1, wherein:
the receiver system is configured to decode the received communications signals into decoded communications signals from each remote unit among the plurality of remote units; and
the analysis circuit is configured to analyze the decoded communications signals for each remote unit among the plurality of remote units to determine performance information for a corresponding remote unit among the plurality of remote units.

4. The performance evaluation system of claim 1, wherein the plurality of signal inputs are each configured to receive the communications signals comprised of uplink communications signals from the remote unit among the plurality of remote units.

5. The performance evaluation system of claim 4, wherein:
the analysis circuit is configured to analyze the received communications signals by being configured to determine the performance information comprising total received uplink power for the received communications signals for each remote unit among the plurality of remote units; and
the performance analysis unit is configured to, for each remote unit, determine the performance indicator comprising a relative received uplink power received by the remote unit based on the received output signal among the plurality of output signals corresponding to the remote unit.

6. The performance evaluation system of claim 4, wherein:
the analysis circuit is configured to analyze the received communications signals by being configured to determine the performance information comprising uplink received signal strength indicator (RSSI) for the received communications signals for each remote unit among the plurality of remote units; and
the performance analysis unit is configured to, for each remote unit, determine the performance indicator comprising a relative RSSI for the remote unit based on the received output signal among the plurality of output signals corresponding to the remote unit.

7. The performance evaluation system of claim 3, wherein:
the analysis circuit is configured to analyze the received communications signals by being configured to determine the performance information comprising total absolute received uplink power for the received communications signals for each remote unit among the plurality of remote units; and
the performance analysis unit is configured to, for each remote unit, determine the performance indicator comprising total absolute received uplink power received by the remote unit based on the received output signal among the plurality of output signals corresponding to the remote unit.

8. The performance evaluation system of claim 3, wherein:
the analysis circuit is configured to analyze the received communications signals to determine a number of physical resource blocks (PRBs) allocated to each remote unit among the plurality of remote units; and
the performance analysis unit is configured to, for each remote unit, determine the performance indicator comprising intensity of cellular activity of the remote unit based on the received output signal among the plurality of output signals corresponding to the remote unit.

9. The performance evaluation system of claim 2, wherein:
the analysis circuit is configured to analyze the received communications signals to determine a traffic load for each remote unit among the plurality of remote units; and
the performance analysis unit is configured to, for each remote unit, determine the performance indicator comprising the traffic load of the remote unit based on the received output signal among the plurality of output signals corresponding to the remote unit.

10. The performance evaluation system of claim 3, wherein:
the analysis circuit is configured to analyze the decoded communications signals to determine a number of user equipment communicating to each remote unit among the plurality of remote units; and
the performance analysis unit is configured to, for each remote unit, determine the performance indicator comprising the number of user equipment based on the received output signal among the plurality of output signals corresponding to the remote unit.

11. The performance evaluation system of claim 2, wherein:
the analysis circuit is configured to analyze the received communications signals to determine an upper and lower side power of the received communications signals for each remote unit among the plurality of remote units; and
the performance analysis unit is configured to, for each remote unit, determine the performance indicator comprising a signaling load for the remote unit based on the upper and lower side power in the received output signal among the plurality of output signals corresponding to the remote unit.

12. The performance evaluation system of claim 3, wherein the performance analysis unit is configured to, for each remote unit, determine the performance indicator comprising a signaling load for the remote unit based on the received output signal among the plurality of output signals corresponding to the remote unit.

13. The performance evaluation system of claim 3, wherein:
the plurality of signal inputs are each configured to receive the communications signals comprised of uplink communications signals from the remote unit among the plurality of remote units;
the analysis circuit is configured to determine the performance information comprising measured signaling power for each user equipment communicating to the remote unit to determine a signaling load for each remote unit among the plurality of remote units; and
the performance analysis unit is configured to, for each remote unit, determine the performance indicator comprising user equipment signaling load of the remote unit based on the received output signal among the plurality of output signals corresponding to the remote unit.

14. The performance evaluation system of claim 1, wherein:
the plurality of signal inputs are each configured to receive the communications signals comprised of downlink communications signals from the remote unit among the plurality of remote units;
the receiver system is configured to decode the received downlink communications signals into decoded downlink communications signals from each remote unit among the plurality of remote units;
the analysis circuit is configured to analyze the decoded downlink communications signals for each remote unit among the plurality of remote units to determine performance information comprising decoded downlink control channels in the decoded downlink communications signals for each user equipment communicating to the remote unit, for each remote unit among the plurality of remote units; and
the performance analysis unit is configured to, for each remote unit, determine the performance indicator comprising user equipment uplink channel allocation for the remote unit based on the received output signal among the plurality of output signals corresponding to the remote unit.

15. The performance evaluation system of claim 3, wherein:
the plurality of signal inputs are each configured to receive the communications signals comprised of uplink communications signals from the remote unit among the plurality of remote units;
the analysis circuit is configured to analyze the received communications signals by being configured to determine the performance information comprising total received uplink power for the received communications signals for each user equipment communication to the remote unit, for each remote unit among the plurality of remote units; and
the performance analysis unit is configured to, for each remote unit, determine the performance indicator comprising a relative received uplink power received by the remote unit for each user equipment communication to the remote unit, based on the received output signal among the plurality of output signals corresponding to the remote unit.

16. The performance evaluation system of claim 3, wherein:
the plurality of signal inputs are each configured to receive the communications signals comprised of uplink communications signals from the remote unit among the plurality of remote units;
the analysis circuit is configured to analyze the received communications signals by being configured to determine the performance information comprising a received signal strength indicator (RSSI) for the received uplink communications signals for each user equipment communication to the remote unit, for each remote unit among the plurality of remote units; and
the performance analysis unit is configured to, for each remote unit, determine the performance indicator comprising an RSSI for each user equipment communication to the remote unit, based on the received output signal among the plurality of output signals corresponding to the remote unit.

17. The performance evaluation system of claim 1, wherein:
the plurality of signal inputs are each configured to receive a user equipment (UE) report as the communications signals from the remote unit among the plurality of remote units in a DAS; and
the analysis circuit configured to analyze the received UE reports for each remote unit among the plurality of remote units to determine performance information for a corresponding remote unit among the plurality of remote units.

18. The performance evaluation system of claim 1, wherein the performance analysis unit is further configured to communicate the performance indicator determined for each remote unit among the plurality of remote units to another system.

19. The performance evaluation system of claim 1, wherein the performance analysis unit is configured to communicate the performance indicator for each remote unit among the plurality of remote units to a base station communicatively coupled to the DAS.

20. The performance evaluation system of claim 1, wherein the receiver system comprises a plurality of individual receivers each comprising a signal input among the plurality of signal inputs, each signal input configured to receive the communications signals from the remote unit among the plurality of remote units.

21. The performance evaluation system of claim 1, wherein the plurality of signal inputs are each configured to receive the communications signals comprised of downlink communications signals from the remote unit among the plurality of remote units.

22. The performance evaluation system of claim 1, further configured to communicate an instruction to cause downlink power of a remote unit among the plurality of remote units to be adjusted based on the determined performance indicator for the remote unit.

23. The performance evaluation system of claim 22, configured to communicate the instruction to cause the downlink power of the remote unit among the plurality of remote units to be increased based on the determined performance indicator for the remote unit.

24. The performance evaluation system of claim 22, configured to communicate the instruction to cause the downlink power of the remote unit among the plurality of remote units to be decreased based on the determined performance indicator for the remote unit.

25. The performance evaluation system of claim 9, further configured to communicate an instruction to cause a remote unit among the plurality of remote units to be shut down in response to the determined traffic load for the remote unit being less than a threshold traffic load level.

26. The performance evaluation system of claim 9, further configured to communicate an instruction to cause a remote unit among the plurality of remote units to be shut down for one or more channels of the received communications signals in response to the determined traffic load for the one or more channels being less than a threshold traffic load level.

27. The performance evaluation system of claim 9, further configured to communicate an instruction to cause a remote unit among the plurality of remote units to be shut down for one or more communications services of the received communications signals in response to the determined traffic load for the one or more communications service being less than a threshold traffic load level.

28. The performance evaluation system of claim 26, further configured to communicate an instruction to cause the remote unit to adjust a gain in the one or more channel in response to the determined traffic load for the one or more channels being less than the threshold traffic load level.

29. The performance evaluation system of claim 27, further configured to communicate an instruction to cause the remote unit to adjust a gain in the one or more communications services in response to the determined traffic load for the one or more communications services being less than the threshold traffic load level.

30. The performance evaluation system of claim 9, further configured to communicate an instruction to cause a remote unit among the plurality of remote units to be decoupled from the DAS in response to the determined traffic load indicating that the remote unit is unloaded.

31. The performance evaluation system of claim 9, further configured to communicate an instruction to cause a new remote unit to be coupled to the DAS in response to the determined traffic load indicating that at least one other remote unit among the plurality of remote units is above a threshold traffic load level.

32. The performance evaluation system of claim 22, further configured to communicate an instruction to cause at least one remote unit among the plurality of remote units to beamform transmissions of downlink communications signals towards a remote coverage area of the at least one other remote unit among the plurality of remote units, in response to the determined performance indicator of the at least one other remote unit.

33.-77. (canceled)
